(19) United States
(12) Patent Application Publication
(10) Pub. No.: US 2019/0176581 A1
(43) Pub. Date: Jun. 13, 2019

(54) VEHICLE DOOR SUN SHADE APPARATUS

(71) Applicant: KASAI KOGYO CO., LTD., Kanagawa (JP)

(72) Inventor: Gosuke ABE, Fujisawa-shi, Kanagawa (JP)

(73) Assignee: KASAI KOGYO CO., LTD., Kanagawa (JP)

(21) Appl. No.: 16/310,705

(22) PCT Filed: Oct. 5, 2016
(86) PCT No.: PCT/JP2016/004479

§ 371 Date: Dec. 17, 2018

(51) Int. Cl. B60J 1/20

(52) U.S. Cl. CPC B60J 1/2086; B60J 1/2038; B60J 1/205; B60J 1/2047

(57) ABSTRACT

A sunshade includes a screen having its lower edge fixed to a take-up shaft biased in an axial rotation direction, and a holder bar provided at an upper edge of the screen so as to extend in the vehicular front-rear direction. A hook member includes a basal part attached to an upper side part of a door sash, and an engaging part continuously provided at the basal part so as to project in the vehicular front-rear direction, the engaging part engaging with the holder bar. The upper side part of the door sash and the engaging part define space between them, the space providing access from each of the cabin side and the door window side to the engaging part.

### CROSS-REFERENCE TO RELATED APPLICATIONS

This application is a National Stage Entry application of PCT International Application No. PCT/JP2016/004479, filed on Oct. 5, 2016, the entire contents of which are hereby incorporated by reference.

### BACKGROUND

### 1. Technical Field

The present invention relates to a vehicular door sunshade apparatus.

### 2. Description of the Background

Conventional vehicular door sunshade apparatuses cover the inner surface of a door window for the purpose of, for example, shielding a cabin from sunshine transmitting through the door window. Such a vehicular door sunshade apparatus is mainly structured by a sunshade housed in a taken-up state, and a hook member provided at a door sash. When using the vehicular door sunshade apparatus, a passenger of the vehicle pulls out, expands, and engages the sunshade with the hook member. Thus, the sunshade is retained at the use position covering the inner surface of the door window.

For example, Japanese Patent Application Publication No. 2004-42772 (hereinafter referred to as “Patent Literature 1”) discloses a sunshade mounting structure including a hook member suspended from the upper side part of a door sash and projecting vehicularly inward (toward the cabin) in the vehicular right-left direction. Further, for example, Japanese Patent Application Publication No. 2002-46469 (hereinafter referred to as “Patent Literature 2”) discloses a sunshade mounting structure including a hook member suspended from the upper side part of a door sash and projecting vehicularly outward (toward the outside of the cabin) in the vehicular right-left direction.

### BRIEF SUMMARY

Here, in the structure disclosed in Patent Literature 1, the sunshade hardly disengages from the hook despite any push-out force applied thereto from the cabin side toward the outside. That is, the sunshade is hardly released with a quick action. In the structure disclosed in Patent Literature 2, the passenger can barely visually recognize the projecting end of the hook member in engaging the sunshade with the hook member. Additionally, this structure forces the passenger to twist his/her hand greatly for the sunshade to be caught from the door window side (the far side) toward the cabin side (the near side), which means that the structure is poor in mountability.

The present invention has been made in view of the foregoing, and an object thereof is to provide a vehicular door sunshade apparatus with excellent mountability on a hook member, still allowing the passenger to release a sunshade with a quick action.

In order to solve the problem, the present invention provides a vehicular door sunshade apparatus including: a sunshade configured to be stored in an end of an interior trim covering a vehicle body panel; and a hook member provided at a door sash guiding a door window in rising and lowering. An inner surface of the door window is covered with the sunshade being pulled out from the end of the door trim and engaged with the hook member. The sunshade includes: a screen having its lower edge fixed to a take-up shaft biased in an axial rotation direction; and a holder bar provided at an upper edge of the screen, the holder bar extending in a vehicular front-rear direction. The hook member includes: a basal part attached to a side part of the door sash, the side part extending in the vehicular front-rear direction; and an engaging part continuously provided at the basal part so as to project in the vehicular front-rear direction, the engaging part engaging with the holder bar. The side part of the door sash and the engaging part define space between the side part of the door sash and the engaging part, the space providing access from each of a cabin side and a door window side to the engaging part.

In the present invention, preferably, the holder bar includes a caught piece caught by the engaging part. Preferably, around the caught piece, an opening allowing the holder bar to pass through the hook member is provided.

Further, in the present invention, the engaging part preferably includes a receiving part being recessed while extending in the vehicular front-rear direction.

Still further, in the present invention, the hook members are preferably disposed respectively at two locations spaced apart by a predetermined distance from each other at the side part of the door sash. The hook members preferably each point at the center of the side part so that projecting ends of the engaging parts oppose to each other.

Still further, in the present invention, the holder bar preferably further includes a knob serving as a grip for the holder bar to be vertically shifted. The caught pieces are preferably disposed at opposite sides with reference to the knob corresponding to the hook members, respectively.

The vehicular door sunshade apparatus of the present invention exhibits excellent mountability on the hook member, still allowing the passenger to release the sunshade with a quick action.

### BRIEF DESCRIPTION OF DRAWINGS

FIG. 1 is a perspective view of a side door to which a vehicular door sunshade apparatus according to the present embodiment is applied as seen from the cabin side.

FIG. 2 is a cross-sectional view taken along line AA in FIG. 1.

FIGS. 3A and 3B are explanatory illustrations showing the main part of the vehicular door sunshade apparatus in an enlarged manner.

FIG. 4 is a perspective view showing a state where a holder bar is engaged with a hook member positioned on the vehicular front side.

FIG. 5 is an explanatory illustration schematically showing a handled state of the vehicular door sunshade apparatus.

FIG. 6 is an explanatory illustration showing a variation of an engaging part.

FIG. 7 is an explanatory illustration showing a variation of the hook member.

FIG. 8 is an explanatory illustration showing a variation of a caught piece.

FIG. 9 is an explanatory illustration showing a variation of the engaging part and the caught piece.

FIG. 10 is an explanatory illustration showing a variation of the hook member.

### DETAILED DESCRIPTION

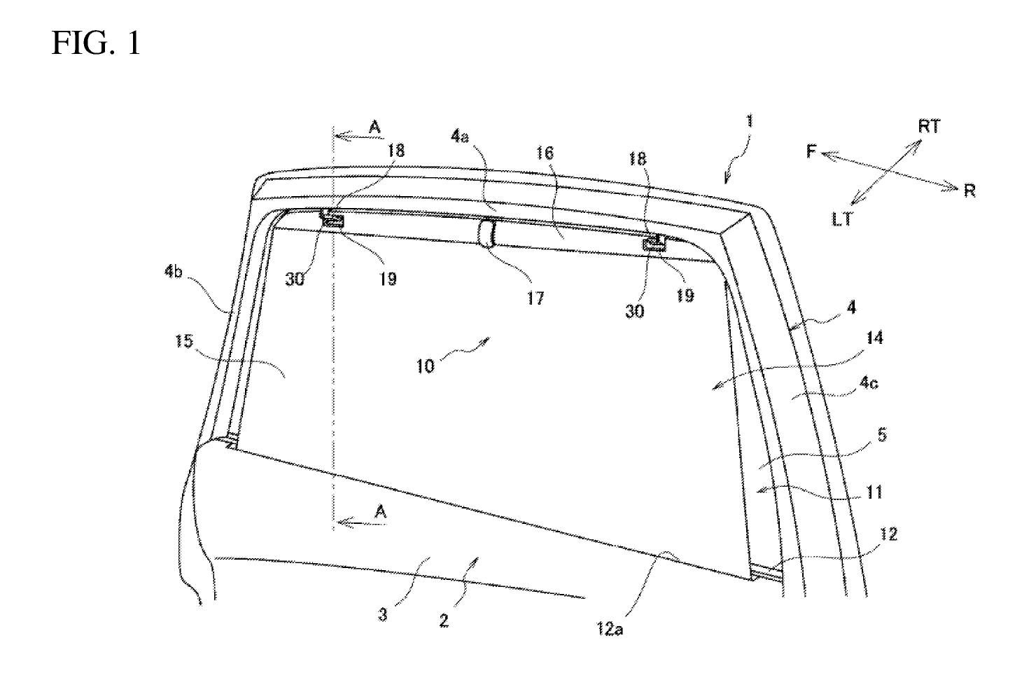

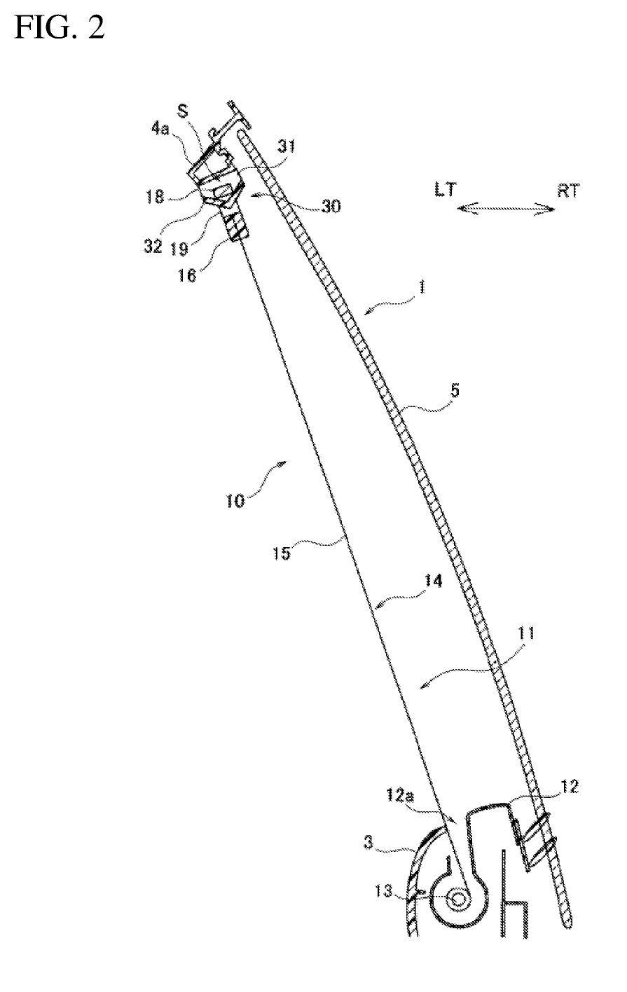

In the following, a description will be given of a vehicular door sunshade apparatus 10 according to the present embodiment. FIG. 1 is a perspective view of a side door 1 to which the vehicular door sunshade apparatus 10 according to the present embodiment is applied as seen from the cabin side. FIG. 2 is a cross-sectional view taken along line AA in FIG. 1. In the drawings, “F” indicates the front direction in the vehicular front-rear direction; “R” indicates the rear direction in the vehicular front-rear direction; “RT” represents the right direction in the vehicular right-left direction; and “LT” represents the left direction in the vehicular right-left direction.

The side door 1 is, for example, a rear side door openably attached to a door opening positioned between a center pillar and a rear pillar. The side door 1 mainly includes a door body 2 including a door outer panel (not shown) forming exterior half the door body, and a door inner panel (not shown) forming interior half the door body.

A door trim 3 is attached onto the interior side of the door body 2, which door trim 3 is an interior trim covering the door inner panel (a vehicle body panel). The door trim 3 is formed of any appropriate synthetic resin material having undergone die-forming. The door trim 3 has a laminated surface on its interior side (the front surface) for both the cushion and decorative purposes.

The side door 1 includes, above the door body 2 (the door inner panel), a door sash 4 guiding the door window 5 in rising and lowering. The door sash 4 is a frame member consisting of: a lower side part (not shown) extending in the vehicular front-rear direction and attached to the door body 2; an upper side part 4a extending in the vehicular front-rear direction positioned above the lower side part; a front side part 4b coupling between the front end of the lower side part and the front end of the upper side part 4a; and a rear side part 4c coupling between the rear end of the lower side part and the rear end of the upper side part 4a.

The vehicular door sunshade apparatus 10 covers the inner surface of the door window 5, to shield the cabin from sunshine transmitting through the door window 5 or ensure privacy of the cabin. The vehicular door sunshade apparatus 10 includes a sunshade unit 11 and a pair of hook members 30.

The sunshade unit 11 mainly includes a door upper trim 12, a take-up shaft 13, and a sunshade 14, and disposed to extend in the vehicular front-rear direction at the upper end of the door trim 3.

The door upper trim 12 is formed of any appropriate synthetic resin material having undergone die-forming. The door upper trim 12 is attached to the upper end of the door trim 3. Part of the door upper trim 12, in conjunction with the door trim 3, forms the decorative surface of the cabin interior. To the door upper trim 12, the take-up shaft 13 taking up the sunshade 14 is installed. The take-up shaft 13 is housed in the space inside the door trim 3. Further, the door upper trim 12 includes a sunshade-dedicated opening 12a which is elongated in the vehicular front-rear direction and defined between the door upper trim 12 and the upper edge of the door trim 3. The sunshade 14 taken up around the take-up shaft 13 is configured to be pulled out from the sunshade-dedicated opening 12a.

The take-up shaft 13 is a shaft member for taking up the sunshade 14. The opposite ends of the take-up shaft 13 are rotatably supported by a pair of bearings provided at the door upper trim 12. The take-up shaft 13 is biased in one axial rotation direction (the direction in which the sunshade 14 is taken up) by, for example, a biasing member such as a spiral spring.

The sunshade 14 includes a screen 15 and a holder bar 16.

The screen 15 is configured to cover the inner surface of the door window 5. The screen 15 is formed of a thin flexible material so as to be taken up around the circumference of the take-up shaft 13, and cut into a predetermined shape conforming to the shape of the door window 5. Further, the screen 15 has the shading function. For example, the screen 15 may be mesh fabric.

The lower edge of the screen 15 is fixed to the take-up shaft 13. By causing the take-up shaft 13 to axially rotate in accordance with the biasing force applied to the take-up shaft 13, the screen 15 is taken up around the take-up shaft 13. On the other hand, by causing the take-up shaft 13 to reversely rotate against the biasing force applied to the take-up shaft 13, the screen 15 is pulled out.

The holder bar 16 allows the passenger to regularly pull out the screen 15 without slack. The holder bar 16 is provided so as to extend in the vehicular front-rear direction at the upper edge of the screen 15. The holder bar 16 is formed of, for example, a hard plate member having a predetermined thickness in the vehicular right-left direction and elongated in the vehicular front-rear direction.

At the center of the holder bar 16 in the vehicular front-rear direction, a knob 17 is attached. The knob 17 is attached to the holder bar 16 on the cabin side, and serves as a grip for the passenger to pull out or take up the screen 15. The knob 17 has a shape greater than the sunshade-dedicated opening 12a, so as not to pass through but is stopped at the sunshade-dedicated opening 12a when the screen 15 is taken up. Thus, the taking-up of the screen 15 is forcibly stopped, and the knob 17 is positioned at the upper end of the door trim 3. When using the screen 15, the passenger pulls up the knob 17 at the upper end of the door trim 3 upward, thereby pulling out the screen 15.

Further, the holder bar 16 is provided with caught pieces 18 for allowing the hook members 30 to catch the holder bar 16. The caught pieces 18 are disposed at the opposite sides of the holder bar 16 with reference to the knob 17, respectively. That is, the caught piece 18 is provided on each of the front end side and the rear end side of the holder bar 16. In the present embodiment, the caught piece 18 on the vehicular front side is provided at the position toward the center (on the knob 17 side) than the front end of the holder bar 16, and the caught piece 18 on the vehicular rear side is provided at the position toward the center (on the knob 17 side) than the rear end of the holder bar 16.

The hook members 30 are provided at the upper side part 4a of the door sash 4. By the holder bar 16 being engaged with the hook members 30, the hook members 30 retain the holder bar 16 at the upper side part 4a of the door sash 4. The hook members 30 are respectively disposed at two locations separated from each other by a predetermined distance in the vehicular front-rear direction, corresponding to the two caught pieces 18 of the holder bar 16.

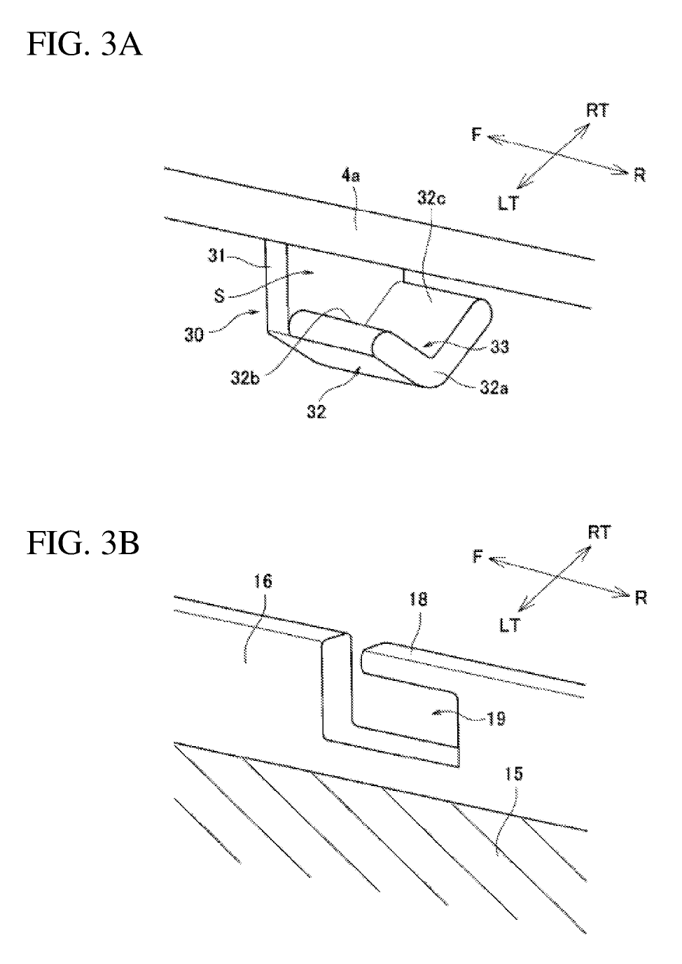

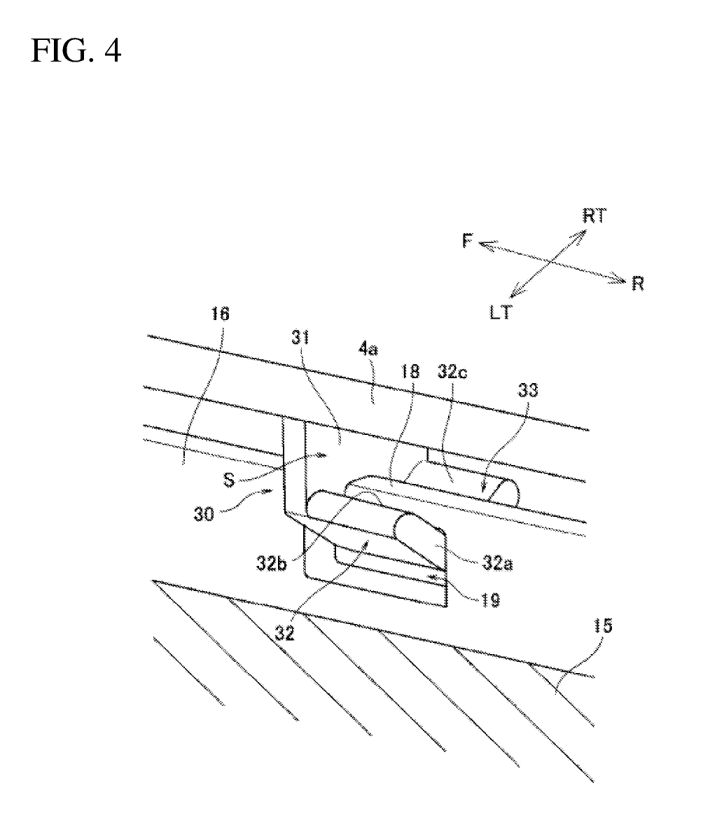

Hereinafter, a description will be given of a detailed structure of the caught pieces 18 and the hook member 30 of the holder bar 16. FIGS. 3A and 3B are explanatory illustrations showing the main part of the vehicular door sunshade apparatus 10 in an enlarged manner. FIG. 3A is a perspective view schematically showing the hook member 30 on the vehicular front side, and FIG. 3B is a perspective view showing the caught piece 18 of the holder bar 16 on the vehicular front side. FIG. 4 is a perspective view showing the state where the holder bar 16 is engaged with the hook member 30 on the vehicular front side.

Each hook member 30 includes a basal part 31 and an engaging part 32. The basal part 31 and the engaging part 32 are integrally formed.

The basal part 31 is suspended from the upper side part 4a of the door sash 4. The basal part 31 includes, for example, a flat plate member having a plane parallel to the vehicular right-left direction.

The engaging part 32 is a site for the holder bar 16 to engage with. In the present embodiment, by the engaging part 32 catching the caught piece 18 of the holder bar 16, the engaging part 32 engages with the holder bar 16. The engaging part 32 is formed continuously from the tip (the lower end) of the basal part 31 and projects in the vehicular front-rear direction. Specifically, one engaging part 32 points at the center of the upper side part 4a of the door sash 4 so that its projecting end 32a opposes to other hook member 30 (the projecting end 32a of other engaging part 32). Here, the engaging part 32 of the hook member 30 on the vehicular front side has its projecting end 32a pointed vehicularly rearward. On the other hand, the engaging part 32 of the hook member 30 on the vehicular rear side has its projecting end 32a pointed vehicularly frontward (see FIG. 1).

The engaging part 32 of the hook member 30 is attached to the tip of the basal part 31 and projects in the vehicular front-rear direction. Thus, between the upper side part 4a of the door sash 4 and the engaging part 32, space S that is continuous in the vehicular right-left direction is formed. The space S provides access from each of the cabin side and the door window 5 side to the engaging part 32 (a receiving part 33 which will be described later).

The engaging part 32 includes a receiving part 33 which is recessed while extending in the vehicular front-rear direction. In the present embodiment, the engaging part 32 includes a pair of planar parts 32b, 32c forming a valley-folded shape having the valley extending in the vehicular front-rear direction. The valley-folded shape forms the recessed receiving part 33. The provision of the receiving part 33 is so devised that the caught piece 18 caught by the engaging part 32 will not easily come off from the engaging part 32.

On the other hand, the caught piece 18 of the holder bar 16 is a site caught by the engaging part 32 of the hook member 30, and provided on the upper edge side of the holder bar 16, for example. Further, around the caught piece 18, an opening 19 defining a gap between the caught piece 18 and the holder bar 16 is provided. The opening 19 is configured to allow the hook member 30 to pass through the gap when the holder bar 16 is shifted in the vehicular right-left direction. The opening 19 is set to have a predetermined shape and dimension corresponding to the shape and dimension of the hook member 30.

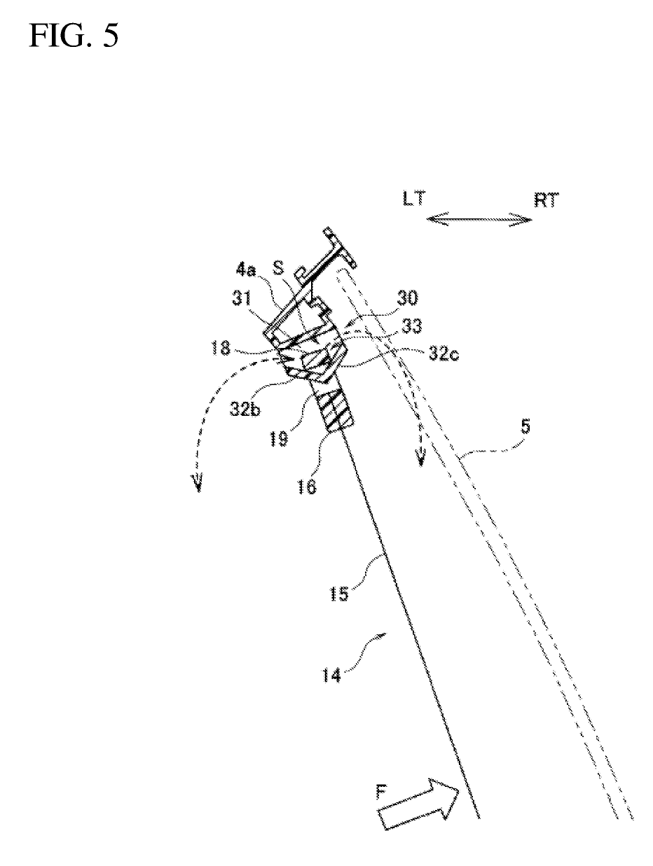

FIG. 5 is an explanatory illustration schematically showing a handled state of the vehicular door sunshade apparatus 10. With the vehicular door sunshade apparatus 10 according to the present embodiment, the passenger grips and vertically shifts the knob 17 with his/her hand, to unwind the sunshade 14 (the screen 15) from the take-up shaft 13 and let it be caught by the hook member 30 thereby expanding the same; alternatively, to release the sunshade 14 from the hook member 30 and let it be taken up around the take-up shaft 13 thereby housing the same.

Specifically, when the passenger grips the knob 17 and lifts the holder bar 16 upward, the screen 15 is pulled out from the sunshade-dedicated opening 12a. When the holder bar 16 reaches the upper side part 4a of the door sash 4, the passenger aligns the pair of caught pieces 18 of the holder bar 16 and the pair of hook members 30 at the upper side part 4a with each other, and lets the caught pieces 18 be caught by the engaging parts 32 while shifting the holder bar 16 from the cabin side (the near side (the left LT side in FIG. 1)) toward the door window 5 side (the far side (the right RT side in FIG. 1)). Thus, the holder bar 16 engages with the hook members 30 and is retained at the upper side part 4a of the door sash 4, that is, the expanded screen 15 is retained at the use position where the screen 15 covers the inner surface of the door window 5.

Here, the space S is secured between the upper side part 4a of the door sash 4 and the engaging part 32. This space S allows the caught piece 18 to pass through. Hence, by the caught piece 18 riding past the upper edge of the near-side planar part 32b and reaching the receiving part 33, the caught piece 18 is stably caught by the engaging part 32.

Further, the opening 19 provided around the caught piece 18 allows the caught piece 18 to pass through the hook member 30 suspended from the upper side part 4a of the door sash 4. Thus, while avoiding interference between the caught piece 18 as well as the holder bar 16 and the hook member 30, the caught piece 18 is caught by the engaging part 32.

On the other hand, in storing the sunshade 14, the passenger gripping the knob 17 and lifting the holder bar 16 shifts the holder bar 16 from the far side to the near side. Thus, the caught piece 18 of the holder bar 16 rides past the upper edge of the near-side planar part 32b from the receiving part 33 and reaches the cabin side. Then, when the passenger shifts the holder bar 16 downward, the screen 15 is retracted into the sunshade-dedicated opening 12a, and taken up around the take-up shaft 13. When the holder bar 16 passes through the sunshade-dedicated opening 12a, finally, the knob 17 is stopped at the sunshade-dedicated opening 12a. This forcibly stops the take-up of the screen 15, and the knob 17 is positioned at the upper end of the door trim 3. Thus, the state where the screen 15 is housed is attained.

Meanwhile, in a situation where the passenger in emergency escapes to the outside from the vehicle with its door window 5 open, the passenger may take a quick action of pushing out the expanded screen 15 with his/her hand. In this case, in response to force F applied to the screen 15 acting from the cabin side to the outside, the upper edge of the screen 15 is pulled diagonally downward. In response to the force acting on the screen 15, a force component toward the outside also acts on the holder bar 16. This causes the caught piece 18 of the holder bar 16 to ride past the upper edge of the far-side planar part 32c from the receiving part 33, to exit outside the cabin. When the caught piece 18 is disengaged from the engaging part 32, the take-up force of the take-up shaft 13 pulls the screen 15 into the sunshade-dedicated opening 12a, whereby the screen 15 and the holder bar 16 are housed. As a result, the door sash 4 becomes open without any interference of the screen 15.

As has been described above, in the present embodiment, the sunshade 14 includes the screen 15 having its lower edge fixed to the take-up shaft 13 biased in an axial rotation direction, and the holder bar 16 provided at the upper edge of the screen 15 so as to extend in the vehicular front-rear direction. The hook member 30 includes the basal part 31 attached to the upper side part 4a of the door sash 4, and the engaging part 32 continuously provided at the basal part 31 so as to project in the vehicular front-rear direction, the engaging part 32 engaging with the holder bar 16. The upper side part 4a of the door sash 4 and the engaging part 32 define the space S between them, the space S providing access from each of the cabin side and the door window 5 side to the engaging part 32.

In this structure, the space S is secured between the upper side part 4a of the door sash 4 and the engaging part 32. Therefore, by allowing the holder bar 16 to shift from the cabin side (the near side) to the door window 5 side (the far side), the holder bar 16 engages with the engaging part 32. This allows the passenger to shift the caught piece 18 to the engaging part 32 while visually recognizing the caught piece 18. That is, the mounting operation is facilitated.

Further, in a situation where the passenger in emergency escapes from the cabin, the passenger pushes out the expanded screen 15 to the outside with his/her hand, whereby a force component in the outside direction acts from the screen 15 on the holder bar 16. In response to the force component, the holder bar 16 engaging with the engaging part 32 passes through the space S, and is disengaged from the engaging part 32. Thus, the take-up force of the take-up shaft 13 pulls the screen 15 into the sunshade-dedicated opening 12a, and the door sash 4 becomes open. Thus, without the necessity of the passenger's vertically shifting the holder bar 16, the passenger's quick action of pushing out the screen 15 causes the screen 15 to be housed (released).

Thus, the vehicular door sunshade apparatus 10 with excellent mountability on the hook member 30, still allowing the passenger to release the sunshade 14 with a quick action, is provided.

Further, in the present embodiment, the provision of the space S allows the passenger to shift the holder bar 16 also from the door window 5 side to the cabin side, to engage the holder bar 16 with the engaging part 32. This structure provides various mounting operations, contributing toward improving the usability.

Still further, in the present embodiment, the holder bar 16 includes the caught piece 18 caught by the engaging part 32 of the hook member 30. Around the caught piece 18, the opening 19 allowing the holder bar 16 to pass through the hook member 30 in the vehicular right-left direction is provided.

In this structure, while avoiding interference between the holder bar 16 and the hook member 30, the holder bar 16 is properly mounted or removed.

Further, in the present embodiment, the engaging part 32 includes the receiving part 33 which is recessed while extending in the vehicular front-rear direction.

In this structure, the caught piece 18 fits into the recessed receiving part 33 and, therefore, this structure minimizes the risk of the caught piece 18 easily coming off from the engaging part 32. Thus, irrespective of any shock or the like applied to the screen 15, the caught piece 18 stably engages with the engaging part 32.

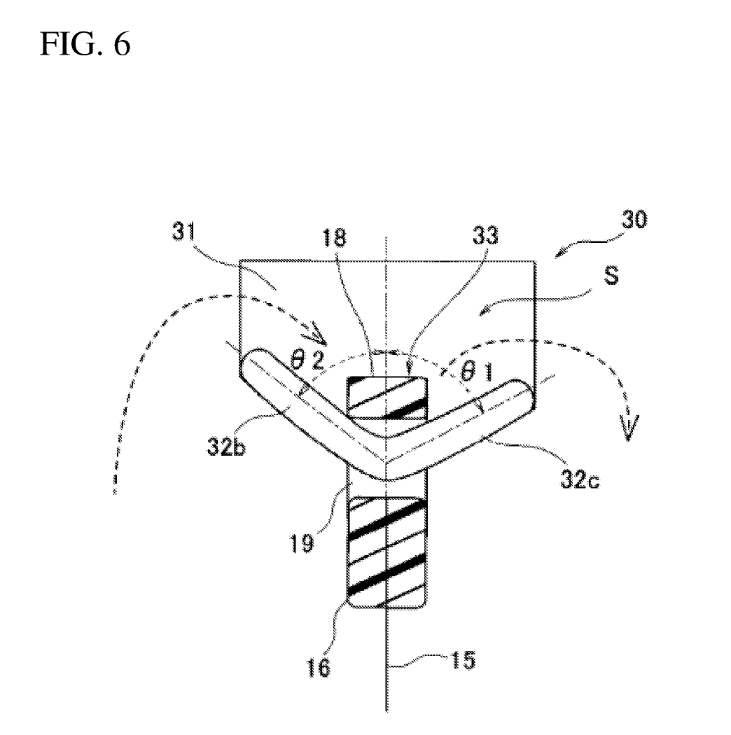

Note that, as shown in FIG. 6, the engaging part 32 of the hook member 30 may be set so that the inclination (θ1) of the far-side planar part 32c is gentle as compared to the inclination (θ2) of the near-side planar part 32b (θ1>θ2). This structure allows the holder bar 16 pushed toward the far side to easily come off. Thus, the screen 15 is easily housed in case of emergency evacuation.

Further, in the present embodiment, the hook members 30 are disposed respectively at two locations spaced apart by a predetermined distance from each other at the upper side part 4a of the door sash 4. The hook members 30 each point at the center of the upper side part 4a so that the projecting ends 32a of the engaging parts 32 oppose to each other.

In this structure, the projecting ends 32a of the engaging parts 32 point at the center and, therefore, the projecting ends 32a of the engaging parts 32 face the passenger. That is, the passenger easily recognizes the position of the projecting ends 32a of the engaging parts 32. Thus, the passenger smoothly lets the caught pieces 18 be caught by the engaging parts 32, which means that the usability improves.

Further, in the present embodiment, the holder bar 16 includes the knob 17 serving as a grip for the holder bar 16 to be vertically shifted. In this case, the caught pieces 18 are disposed at opposite sides with reference to the knob 17 corresponding to the hook members 30, respectively.

This structure allows the passenger to visually recognize the caught pieces 18 on the opposite sides with reference to the knob 17 serving as a grip at substantially equivalent distances. Therefore, the passenger can operate the knob 17 while evenly monitoring the caught pieces 18 and the engaging parts 32 positioned respectively on the front side and the rear side with reference to the operated knob 17.

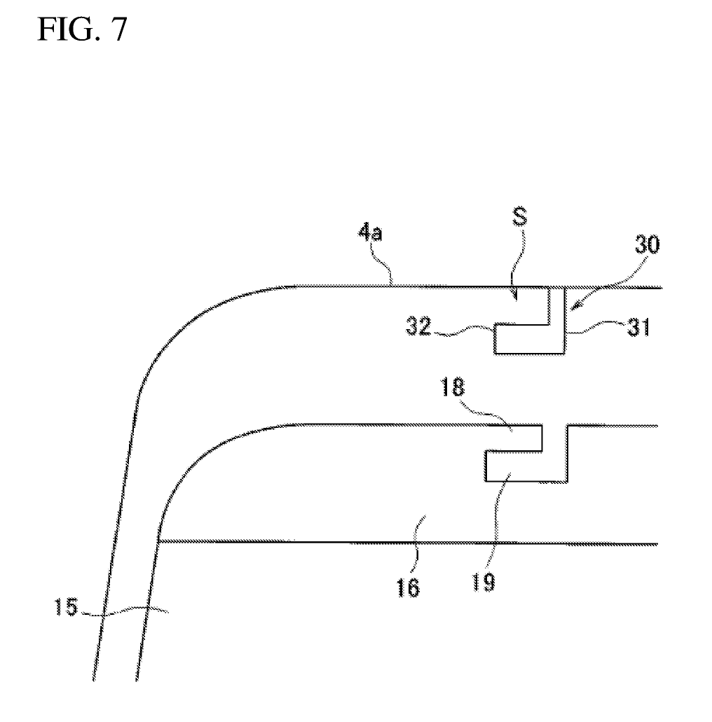

Note that, in the above-described embodiment, the hook members 30 positioned respectively on the front side and the rear side are disposed so as to point at the center. However, as shown in FIG. 7, the hook members 30 may be disposed so as to point outward.

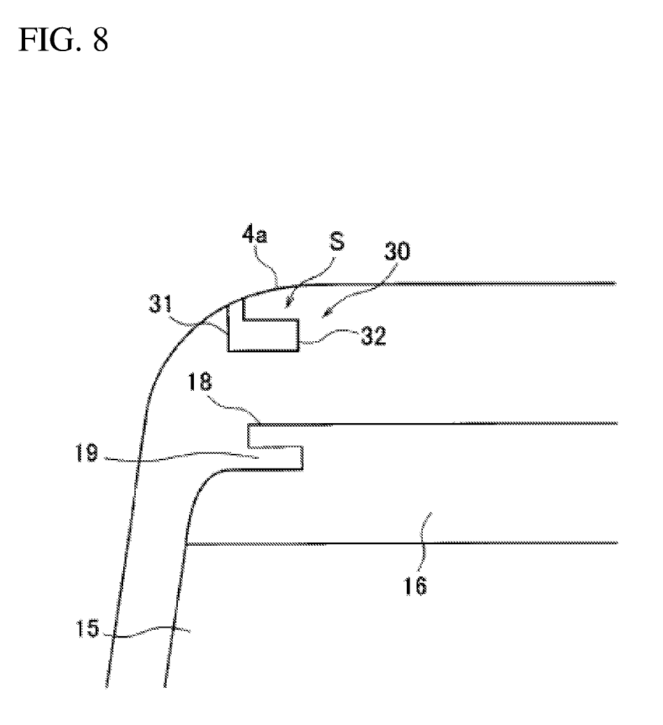

Further, in the present embodiment, the caught pieces 18 are positioned toward the center than the ends of the holder bar 16. However, as shown in FIG. 8, the caught pieces 18 may be disposed at the ends of the holder bar 16.

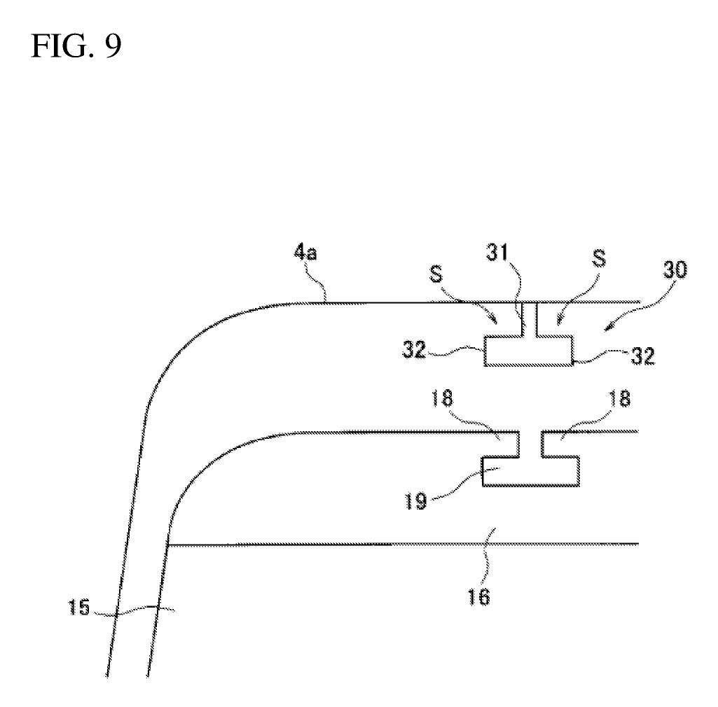

Further, in the present embodiment, the engaging part 32 of each hook member 30 projects just in one side in the vehicular front-rear direction. However, as shown in FIG. 9, the engaging part 32 may include the engaging part 32 on both sides in the vehicular front-rear direction.

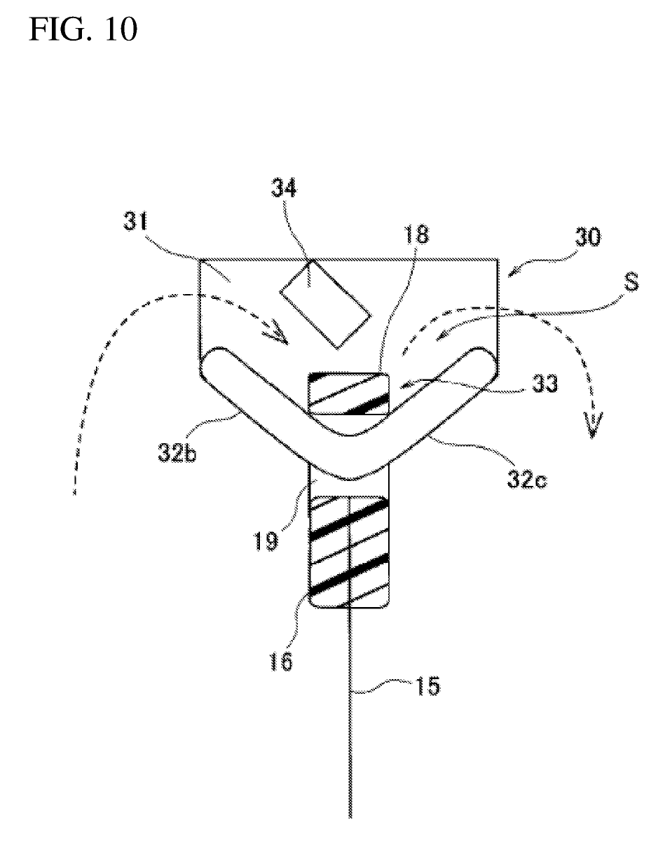

Further, as shown in FIG. 10, each hook member 30 may include a restricting member 34 in the space S. In letting the caught piece 18 be caught by the engaging part 32, the restricting member 34 restricts the caught piece 18 from exiting toward the door window 5 side past the engaging part 32. The restricting member 34 enables the caught piece 18 to be caught stably by the engaging part 32.

Further, in the present embodiment, while the hook members 30 are provided by two pieces for the purpose of stably retaining of the holder bar 16, the hook member 30 may be provided by one in number.

In the foregoing, the description has been given of the vehicular door sunshade apparatus according to the present embodiment. The present invention is not limited to the embodiment, and can be modified in various manners within the scope of the invention. For example, while it has been described that the sunshade is pulled out upward in use, the sunshade may be housed in the end of the headliner (an interior trim), and the sunshade may be pulled out downward in use.

### REFERENCE SIGNS LIST

1: side door

2: door body

3: door trim

4: door sash

4a: upper side part

4b: front side part

4c: rear side part

5: door window

10: vehicular door sunshade apparatus

11: sunshade unit

12: door upper trim

12a: sunshade-dedicated opening

13: take-up shaft

14: sunshade

15: screen

16: holder bar

17: knob

18: caught piece

19: opening

30: hook member

31: basal part

32: engaging part

32a: projecting end

32b, 32c: planar parts

33: receiving part

34: restricting member

1. A vehicular door sunshade apparatus comprising:
a sunshade configured to be stored in an end of an interior trim covering a vehicle body panel; and
a hook member provided at a door sash guiding a door window in rising and lowering, wherein
an inner surface of the door window is covered with the sunshade being pulled out from the end of the interior trim and engaged with the hook member,
the sunshade includes:
a screen having its lower edge fixed to a take-up shaft biased in an axial rotation direction; and
a holder bar provided at an upper edge of the screen, the holder bar extending in a vehicular front-rear direction, wherein
the hook member includes:
a basal part attached to a side part of the door sash, the side part extending in the vehicular front-rear direction; and
an engaging part continuously provided at the basal part so as to project in the vehicular front-rear direction, the engaging part engaging with the holder bar, wherein
the side part of the door sash and the engaging part define space between the side part of the door sash and the engaging part, the space providing access from each of a cabin side and a door window side to the engaging part.

2. The vehicular door sunshade apparatus according to claim 1, wherein the engaging part includes a receiving part being recessed while extending in the vehicular front-rear direction.

3. The vehicular door sunshade apparatus according to claim 1, wherein
the holder bar includes a caught piece caught by the engaging part, and
around the caught piece, an opening allowing the holder bar to pass through the hook member is provided.

4. The vehicular door sunshade apparatus according to claim 1, wherein
the hook members are disposed respectively at two locations spaced apart by a predetermined distance from each other at the side part of the door sash, and
the hook members each point at a center of the side part so that projecting ends of the engaging parts oppose to each other.

5. The vehicular door sunshade apparatus according to claim 3, wherein
the hook members are disposed respectively at two locations spaced apart by a predetermined distance from each other at the side part of the door sash,
the hook members each point at a center of the side part so that projecting ends of the engaging parts oppose to each other,
the holder bar includes a knob serving as a grip for the holder bar to be vertically shifted, and
the caught pieces are disposed at opposite sides with reference to the knob corresponding to the hook members, respectively.
